(19) United States
(12) Patent Application Publication
(10) Pub. No.: US 2003/0071847 A1
(43) Pub. Date: Apr. 17, 2003

(54) Notification of messages to a terminal by means of vector image

(75) Inventor: Luc Vacquie, Saint Jean L'herm (FR)

Correspondence Address: LOWE HAUPTMAN GOPSTEIN GILMAN & BERNER, LLP, 1700 Diagonal Road, Suite 310, Alexandria, VA, 22314, US

(73) Assignee: FRANCE TELECOM

(21) Appl. No.: 10/269,000

(22) Filed: Oct. 11, 2002

(30) Foreign Application Priority Data
Oct. 15, 2001 (FR) 01-13296

(51) Int. Cl. G09G 5/00

(52) U.S. Cl. 345/772

(57) ABSTRACT

For notifying messages received in a messaging system to a terminal, for example a mobile radio telephone, a notification server sends the terminal a notification including addresses of graphical elements supplied by message analyzer means and in corresponding relationship to events of all of the messages received. In the terminal, an image construction system connected to a graphical element database constructs and shows a behavior of the vector image made up of graphical elements selected in the database as a function of the graphical element addresses included in the notification transmitted.

### BACKGROUND OF THE INVENTION

1. Field of the Invention

The present invention relates to a system for notifying visually the status of a user's messaging system.

2. Description of the Prior Art

There already exist message notifying systems for cellular mobile radio telephone terminals that show a text message indicating “You have mail” on the screen of a terminal or display a pictogram, representing an envelope, for example, on the screen of the terminal to indicate to the user that the user's messaging system has received voicemail or faxes, for example, or use a ringer to announce the reception of a message in the messaging system.

For example, notifying systems of the above kind are installed in various message receiving systems to prompt users to read stored messages.

In a message notifying system of the above kind, the user must read the messages one by one in each of the various message receiving systems available, which is relatively inconvenient.

To eliminate this problem, a known notifying system notifies received messages by means of a vector image displayed on the terminal and comprising a plurality of variable graphical elements representative of events relating to all received messages. The notifying system comprises a system for analyzing received messages and a system for constructing images linked to a database of graphical elements which are included in a unit containing a modem and connected to the terminal, for example via a Peritel connector of a television set constituting the terminal.

### OBJECT OF THE INVENTION

The main object of this invention is to provide a message notifying system in which the message receiving means are far away from the terminal and which manages the construction and display of the vector image in the terminal itself.

### SUMMARY OF THE INVENTION

A message notifying system for notifying a terminal of messages received in message receiving means by means of a vector image displayed on the terminal comprises message analyzer means connected to the receiving means to define first events relating to all messages received.

According to the invention, the notifying system comprises a notification server which transmits to the terminal via a telecommunication network a notification comprising addresses of first graphical elements supplied by the analyzer means in corresponding relationship to first events, and the terminal comprises image construction means connected to a database of first graphical elements for generating a vector image comprising at least first graphical elements depending on the first events. The construction means constructs and shows in the terminal a behavior of the vector image made up of first graphical elements selected in the database as a function of first graphical element addresses included in the notification transmitted.

The invention can advantageously show the status of the message receiving means at a glance by means of a vector image, such as a character, whose behavior is representative of that status, i.e. of all of the analyzed messages received in a unified messaging system that is not permanently connected to the terminal, but is Is located somewhere else in the telecommunication network to which the terminal is connected. As will become clear hereinafter, the first graphical elements of the vector image that the user has chosen are not transmitted as such by the notification server, but instead in the form of addresses designating first graphical elements prestored in the database included in the terminal itself.

The first graphical elements necessary for constructing the behavior of the vector image to be displayed can depend on local data prestored in the terminal, such as call numbers or other subaddresses. The terminal includes then means for storing a directory of subaddresses respectively associated with first graphical elements which are all of a predetermined type. The image construction means selects a first graphical element of the predetermined type in the directory associated with a subaddress read in the database and received with the first graphical element address designating the predetermined type of first graphical element.

The construction of a behavior of the vector image can also involve second graphical elements depending on events relating to the operation of the terminal and detected by at least one detector means included in the terminal. In this latter case, the image construction means constructs and shows the vector image also using second graphical elements which are selected in the database as a function of second graphical element addresses supplied by the detector means in corresponding relationship to second detected events relating, for example, to the charge in a terminal battery or to the RF power received if the terminal is a the mobile telephone terminal.

### BRIEF DESCRIPTION OF THE DRAWINGS

Further features and advantages of the invention will be apparent more clearly from the reading of the following description of several preferred embodiments of the invention shown in the corresponding accompanying drawings, in which:

FIG. 1 is a schematic block diagram of a message notifying system according to a preferred embodiment of the invention when the terminal is a mobile telephone terminal receiving notifications in the form of short messages;

FIG. 2 is a table showing the correspondence of events in a unified messaging system relating to messages received intended for the terminal and first graphical elements prestored in the terminal; and

FIG. 3 is a diagram showing a vector image in the form of a character with the meaning of events corresponding to the portions and accessories of the character.

### DESCRIPTION OF THE PREFERRED EMBODIMENT

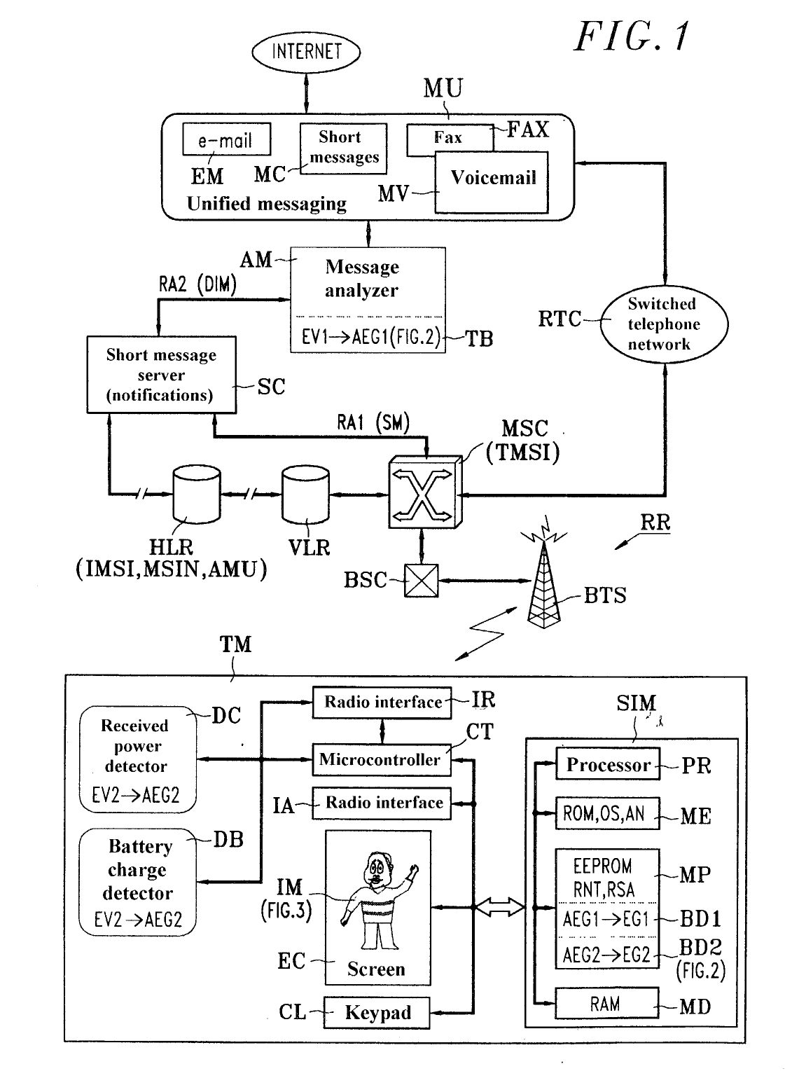

The message notifying system according to the invention illustrated in FIG. 1 relates to a cellular mobile radio telephone terminal TM included in a cellular radio telephony network RR, for example a GSM network, although the network RR can be a UMTS network. The main fixed means connecting the terminal TM to a short message server SC (Service Center) are shown in FIG. 1. The terminal TM can receive notifications in the form of short messages SM transmitted by the server SC.

The main fixed means in the network RR are a current base transceiver station BTS providing radio coverage of the current cell in which the mobile terminal TM is temporarily located, a base station controller BSC and a mobile-services switching center MSC. The switching center MSC is connected to at least one exchange of the public switched telephone network RTC and is associated with a visitor location register VLR. The register VLR manages at least one location area comprising a few cells of the network RR and stores temporarily identities and profiles of users located in the area. The mobile telephone network RR also comprises a. home location register HLR connected to mobile service switching centers MSC via the signaling network of the mobile telephone network. The register HLR primarily contains a database storing for each of the mobile terminals like the terminal TM the international identifier (IMSI) of the user whose user identity module SIM is removably incorporated in the terminal TM, the identification number (MSIN) of the mobile user in the mobile radio telephony network RR, and the number of the register VLR temporarily servicing the mobile terminal TM and updated at the time of handovers between location areas.

The short message server SC is connected to a plurality of switching centers MSC of the mobile radio telephony network RR via an access network RA1, for example an integrated services digital network ISDN, an X.25 packet network, or an ATM network.

The mobile terminal TM conventionally comprises a user interface comprising an audio interface IA, a screen EC and a keypad CL, as well as a removable Subscriber Identity Module SIM, and is organized around a microcontroller CT equipped with a browser and also servicing other circuits, such as a radio interface IR with the base transceiver station BTS.

Insofar as the invention is concerned, the terminal TM includes detector means for detecting events relating to operation of the terminal. As known in the art, the detector means includes at least one battery charge level detector DB which compares the level of charge in the battery in the terminal TM to a plurality of thresholds and a radio coverage detector DC which compares the maximum RF power received from at least the base transceiver station BTS with which the terminal is communicating to a plurality of power thresholds.

The identity module SIM includes a microcontroller comprising a microprocessor PR, a read-only memory ME of type ROM which holds an operating system OS of the module SIM and dedicated applications such as a notification application AN according to the invention, a programmable nonvolatile memory MP of type EEPROM which contains data relating to the holder of the SIM card and to the operator of the mobile radio telephony network RR, in particular the international identifier TMSI of the user holding the SIM card, the identifier TMSI temporarily assigned to the user by the register VLR, a profile of the user's subscription to the network RR, a private telephone number directory RNT, security data and graphical element databases BD1 and BD2 according to the invention, and a random access memory MD of type RAM for storing data exchanged with the microcontroller CT of the terminal TM.

The message notifying system further comprises a unified messaging system MU and a message analyzer AM. The address AMU of the messaging system is included in the user profile written into the home location register HLR.

The unified messaging system MU combines for each of a plurality of users various means for receiving respective messages, for example an electronic mailbox EM (e-mail) supported by a POP3 (Post Office Protocol, version 3) server or an IMAP4 (Internet Message Access Protocol, version 4) server connected to the Internet, a facsimile receiver FAX connected to the switched telephone network RTC, and a voicemail answering and recording equipment MV also connected to the network RTC. When the terminal is a mobile telephone terminal, the unified messaging system further comprises a receiver MC extracted from the server SC for receiving short messages addressed to the terminal TM. Instead of this, the messaging system MU can be installed at least partly in a private automatic branch exchange PABX.

The message analyzer AM is connected to or incorporated in the unified messaging system MU. It analyzes the various messages EM, FAX, MV and MC that have not yet been read in the unified messaging system MU and relating to the user of the terminal TM, and draws up a table of analyzed messages classified by size, sender, urgency, whether or not the sender is included in a directory of addresses added to as and when messages are received, and other characteristics of the received message.

The message analyzer AM includes an address table TB which matches an event EV1 characterizing all of the received messages relating to the user in the unified messaging system MU to the address AEG1 of a predetermined graphic element EG1 of a vector image TM representative of a notification of received messages to be displayed on the screen EC of the terminal TM.

The vector image IM can be an anthropomorphic image, such as a character, as shown diagrammatically on the screen EC in FIG. 1, or a zoomorphic image. The image TM is made up of a combination of a predetermined number of graphical elements EG1 chosen from a collection of predetermined graphical elements. The chosen graphical elements are juxtaposed to constitute one instance of the vector image IM.

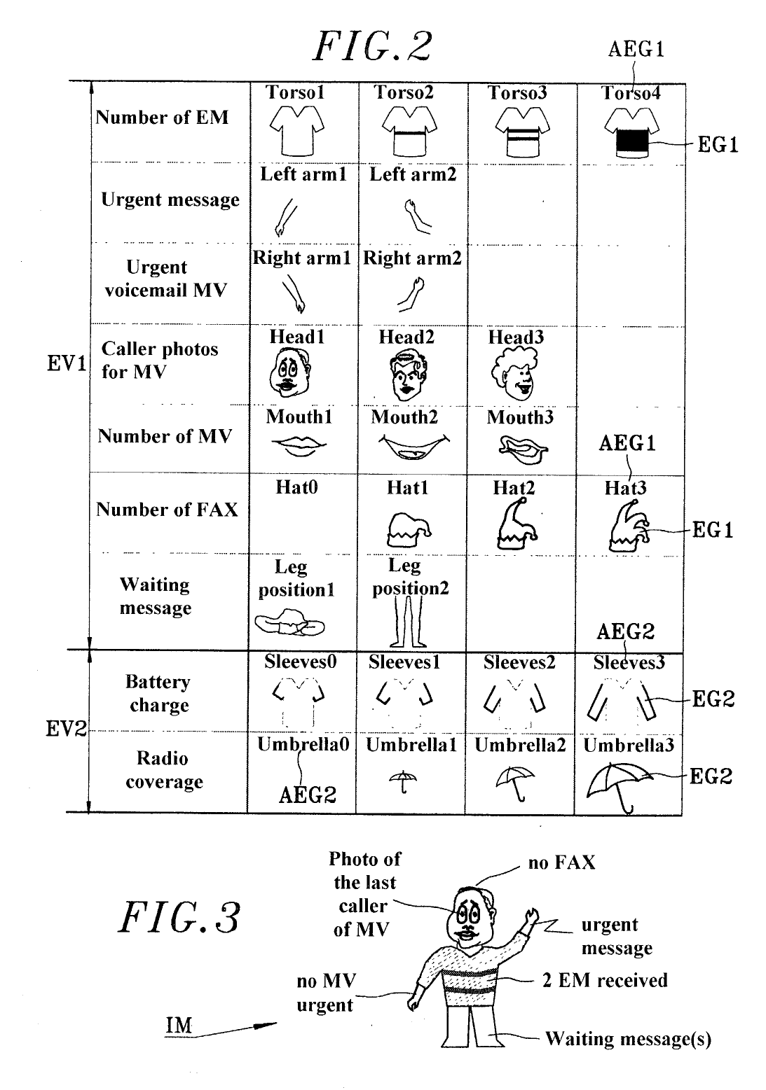

For example, as shown in the table in FIG. 2, if the graphical image IM represents a character, the image is made up of graphical elements that can comprise a head, a body, two arms and two legs, and various garments such as trousers or dress, T-shirt and hat, and various accessories such as an aura, a camera, a radio-cassette player, a suitcase, etc. In the context of the invention, a graphical element can also be a text or a telephone number, for example, or an IP (Internet Protocol) address. Moreover, some of the preceding graphical elements contribute to the representation of a behavior of the character, thanks to different positions of the legs or different lengths of the arms or legs or sleeves, or to different signs on a T-shirt, or to different numbers of bells on a hat, etc.

Instead of this, rather than defining each graphical element of the same type by different images pixel by pixel (i.e. as a bitmap), for example different images including shorter or longer sleeves, the graphical elements of the same type, such as a body part or accessory, are associated with respective attributes indicating modifications relative to a reference graphical element for that type; the attributes can be the size, the height, the length or the width of the graphical elements such as sleeve, hat or limb, or the color or the number of sub-elements such as the bells on the hat.

In the remainder of the description, it is considered that the address AEG1 of a graphical element EG1 designates the graphical element defined in pixels in the database BD1 contained in the module SIM of the terminal TM or an identifier of the type of graphical element with its attributes in order to reconstitute it in the terminal TM as a function of the address AEG1.

The message analyzer AM defines events relating to all of the messages received by the unified messaging system MU and relating to the user who owns the SIM card, each event in response to at least one new message deposited in the messaging system, in order to translate these events EV1 into graphical element addresses AEG1 in the address table TB that designate respective prestored graphical elements EG1 in the database BD1 for constructing the character IM to be displayed on the screen EC. The following events detected in the messaging system by the analyzer AM correspond to the following graphical elements, for example:

the number of electronic mail messages EM not yet read is indicated by a corresponding number of horizontal lines on the T-shirt, the symbol “+” or a black rectangle, for example, on the T-shirt indicating that at least three messages are waiting to be read;

at least one of the arms is raised to indicate that the messaging system MU has received at least one urgent message, and the arm is in a lower position to indicate that there is no urgent message;

the other arm is raised to indicate that the answering and recording equipment has received at least one urgent voicemail MV;

the more open the mouth, the greater the number of voicemails MV to be read in the answering and recording equipment;

the number of bells on the hat indicates the number of facsimile messages FAX waiting, the symbol “+” on the hat indicating that there are three or more facsimile messages waiting;

legs in the crossed-legs position indicate that there is no message waiting and legs in the standing position indicate that there is at least one message waiting in the messaging system MU.

The combination of the events EV1 defines a behavior, i.e. a stimulus, of the character IM to be displayed in the terminal.

Thus the behavior of the character IM is described by a succession of addresses AEG1 of graphical elements EG1 constituting a descriptor DIM of the behavior of the character IM. For example, the character IM is described by a descriptor DIM including the addresses AEG1 of the graphical elements EG1 relating to the number of horizontal lines on the torso, to the position of the left arm, to the length of the right arm, to the number of bells on the hat, to the position of the legs, to the length of the sleeves, and to the telephone number of the last caller who left a voicemail MV in the answering and recording equipment. FIG. 3 shows an example of a vector image consisting of a particular behavior of a character with the meaning of the corresponding events.

The descriptor DIM of the status of the unified messaging system relating to the messages addressed to the terminal TM is transmitted to the notification server SC either directly or via an access network RA2 of one of the types already defined for the access network RA1. The descriptor DIM is then encapsulated in a short message SM, as a notification of the received messages, by the server SC to be transmitted to the mobile terminal TM via the networks RA1 and RR. The server SC receives with the descriptor DIM the mobile user number MSIN that the messaging system MU associates with each user so that the server SC can consult the home location register HLR to read therein the temporary identity TMSI allocated to the user and the address of the current mobile services switching center MSC to which the terminal TM is connected. Thus the server SC transmits the short message SM comprising the descriptor DIM and the temporary identity TMSI to the terminal TM via the current switching center MSC. If the terminal TM is not switched on, or is not within the coverage area of the network RR, the server SC holds the descriptor DIM associated with the subscriber number MSIN in a queue and consults the register HLR periodically until it can read therein a current switching center MSC address covering a location area in which the terminal TM is located.

During the exchange of short messages between the server SC and the module SIM, the terminal TM and in particular its microcontroller CT are transparent to information contained in the short messages SM, such as the descriptor DIM, and does not interpret it.

In response to the short message containing the descriptor DIM comprising a series of addresses AEG1 of graphical elements EG1, possibly with their attributes, the notification application AN in the memory ME of the module SIM manages the construction of the vector image IM representing the character. Each graphical element address AEG1 designates a corresponding graphical element EG1 in the database BD1 of the nonvolatile memory MP so that the various graphical elements designated by the addresses received and contained in the descriptor DIM are combined to construct the graphical image IM and thus display it on the screen EC of the terminal TM.

If an address AEG1 received is accompanied by the attributes of the corresponding graphical element EG1, the application AN constructs the element EC1 on the basis of the prestored reference graphical element which is modified as a function of the attributes. For example, if the address received designates a sleeve with a given length as its attribute, the corresponding sleeve is constructed from the shortest sleeve and a length enlargement factor corresponding to the length received. In another example, if the address received designates the torso with two horizontal stripes, the corresponding torso is constructed from a reference torso to which two stripes are added. The interpretation is similar for other attributes such as color, text and any other change of size.

In a more complete embodiment of the invention, the construction of a behavior of a graphical image IM uses local data stored beforehand in the terminal TM and more specifically in the user module SIM. In this embodiment, a prestorage system in the terminal TM, such as the nonvolatile memory MP in the module SIM, prestores a directory of subaddresses RSA respectively associated with graphical elements which are all of the same predetermined type.

In response to a graphical element address AEG1 designating the predetermined type of graphical element and transmitted with a subaddress serving as an attribute in a short message SM by the server SC, the notification application AN selects the graphical element of the predetermined type associated with the subaddress read in the base BD1 and received with the graphical element address AEG1 designating any graphical element of the predetermined type. For example, the directory RSA matches subaddresses which are telephone numbers of callers likely to deposit voicemail MV, or EM message source addresses, prestored in the directory RNT by the user, to respective photographs of faces of callers that have been scanned and prestored. The application AN then selects the photograph of the face in the directory RSA associated with the number of the last caller in the base BD1 and received with the graphical element address that designates any a priori character face, by way of graphical element. If the number associated with the graphical element address received designating a face is not recognized and therefore has not been prestored in the directory RSA with a corresponding particular caller face, the application AN designates a standard graphical element of the predetermined type, in this instance a standard character face, for example under the number of a caller who is not listed in the directory RSA and/or the name of a caller who is listed in the directory RNT.

Thus the behavior of the character IM displayed on the screen EC reflects diverse instantaneous characteristics of the unified messaging system MU relating to the user who owns the module SIM.

The user can choose the type of vector image IM to be displayed, which can be a little man, a woman, an animal, etc., as well as the behavior of the graphical form chosen, by imposing the corresponding relationship between the various graphical elements constituting the image IM and the events EV1 reflecting the status of the unified messaging system, and also by imposing the various ranges for variation of the attributes of the graphical elements, such as size, any dimension, color, etc. The vector image type and the graphical elements of the graphical image corresponding to events are preferably selected beforehand by the user by connecting the terminal TM to a server (not shown), for example via the Internet. The server downloads the selected graphical element databases BD1, BD2 and the program for constructing behaviors of the selected image into the notification application AN, allowing construction and combination of the graphical elements into behaviors of the selected image as a function of the various attribute variation ranges.

As already stated, the terminal TM includes detectors DB and DC for detecting events EV2 relating to operation of the terminal. To each internal event EV2 detected by the detectors DB, DC there corresponds a graphical element address AEG2.

For example, one address AEG2 designates a graphical element representing a predetermined range of variation in the charge in the battery of the terminal TM between two predetermined thresholds; in FIG. 2, the length of the sleeves of the character is proportional to the level of charge of the battery, the “Sleeves 0/1/2/3” addresses respectively indicating a battery with less than 10% charge, from 10% to 50% charge, from 50% to 80% charge, and more than 80% charge. In another example, the RF power level received on the traffic channel between the terminal TM and the current base transceiver station BTS is designated by an address AEG2 indicating that it is between two predetermined thresholds in the coverage detector DC; in FIG. 2, the width of an umbrella above the character IM increases with the RF power received by the terminal TM, in accordance with predetermined ranges of variation. In a further example, an element EG2 represents a range of variation of the ambient temperature indicated by a temperature sensor incorporated in the terminal.

The address AEG2 with its attributes, for example the designation of a range of variation of the battery charge or of the received RF power, is transmitted by the microcontroller CT to the module SIM in which the application AN matches the received address AEG2 to the corresponding graphical element EG2 in the second database BD2 in the memory MP. The vector image IM representing a character, for example, is thus complemented by graphical elements EG2 whose behavior is representative of events detected while the terminal is operating.

After the vector image IM is displayed on the screen EC of the terminal TM, the microprocessor PR deletes the received short message SM in the memory MD, and waits for subsequent addresses AEG1 and AEG2 in response to events signaled by the analyzer AM and the detectors DB and DC, in order to refresh the displayed image.

The invention is not limited to the embodiment described with reference to FIG. 1.

Instead of notifying the status of messages received, produced in the form of at least one short message SM by the server SC, each notification is transmitted in the form of at least one packet with a higher bit rate by means of a packet-switching access network with roaming management and access via the GPRS General Packet Radio Service. The server SC and the access network RA1 are then replaced by a Gateway GPRS Support Node (GGSN) and a Serving GPRS Support Node (SGSN) interconnected by the packet network GPRS, both to the register HRL, and respectively to the message analyzer AN and to base station controllers BSC of the mobile telephone network RR.

More generally, the terminal can be a mobile personal telecommunication device or tool such as a personal digital assistant (PDA) or a portable microcomputer fitted with a cellular radio telephone transceiver module.

The terminal can equally be connected to a fixed telecommunication line, such as a personal computer PC connected to an exchange of the switched telephone network RTC. In this embodiment, the unified messaging system MU and the analyzer AM, on the one hand, and a notification server generating notifications containing descriptors DIM, on the other hand, constitute service control points (PCS) which are connected via the signaling network associated with the telephone network RTC to service switching points (SSP) connected to autonomous routing exchanges of the network RTC. A pair of autonomous routing exchanges and service access exchanges in the network RTC is substantially equivalent to the MCS/VLR combination in the radio telephony network RR.

In further embodiments, the terminal is a television set containing all of the functions described in connection with the terminal TM and the module SIM in relation to the invention, and which is connected to a telecommunication line, such as a telephone line of the network RTC or a cable network line. In the latter case, the cable network head end contains a suitable notification server equivalent to the server SC shown in FIG. 1.

What we claim is:

1- A system for notifying a terminal of messages received in message receiving means by means of a vector image displayed on said terminal,
said notification system comprising message analyzer means connected to said receiving means to define first events relating to all messages received, and a notification server which transmits to said terminal via a telecommunication network a notification comprising addresses of first graphical elements supplied by said analyzer means in corresponding relationship to first events, and
said terminal comprising detector means for detecting second events relating to operation of said terminal, image construction means and a database of first and second graphical elements, said construction means constructing and showing in said terminal a behavior of a vector image made up of first graphical elements which are selected in said database as a function of first graphical element addresses included in said notification transmitted, and made up of second graphical elements which are selected in said database as a function of second graphical element addresses supplied by said detector means in corresponding relationship to detected second events.

2- The system claimed in claim 1, wherein said terminal comprises means for storing a directory of subaddresses respectively associated with first graphical elements which are all of a predetermined type, and said image construction means selects a first graphical element of said predetermined type in said directory associated with a subaddress read in said database and received with said first graphical element address designating said predetermined type of first graphical element.

3- The system claimed in claim 2, wherein said subaddresses are telephone numbers and said first graphical elements which are all of said predetermined type are scanned photographs of the faces of callers corresponding to respective numbers.

4- The system claimed in claim 2 wherein, if said image construction means does not recognize a subaddress in said directory, then the corresponding first graphical element is a standard graphical element.

5- The system claimed in claim 1, wherein one second event relating to operation of said terminal is the charge in a battery of a terminal, which is within a predetermined range of variation.

6- The system claimed in claim 1, wherein one second event relating to operation of said terminal is the RF power received by said terminal, which is within a predetermined range of variation.

7- The system claimed in claim 1, wherein said terminal is a cellular mobile radio telephone terminal including a subscriber identity module removable from said terminal and incorporating said image construction means and said database of first and second graphical elements.

8- The system claimed in claim 1, wherein said first and second graphical elements of said vector image are selected in a server from said terminal in order to download said database with the selected graphical elements in corresponding relationship to first and second events and a program for constructing vector image behaviors in said terminal.
